(19) United States
(12) Patent Application Publication
(10) Pub. No.: US 2024/0413688 A1
(43) Pub. Date: Dec. 12, 2024

(54) SHAPED CONDUCTOR FOR A WINDING OF AN ACTIVE PART OF A ROTATING ELECTRIC MACHINE, ACTIVE PART FOR A ROTATING ELECTRIC MACHINE AND ASSOCIATED PRODUCTION METHOD

(71) Applicant: Valeo eAutomotive Germany GmbH, Erlangen (DE)

(72) Inventors: Christian FINGER-ALBERT, Bad Neustadt a.d.Saale (DE); Boris DOTZ, Bad Neustadt a.d.Saale (DE); Sebastian BEETZ, Bad Neustadt a.d.Saale (DE); David FÖRSTER, Bad Neustadt a.d.Saale (DE)

(73) Assignee: Valeo eAutomotive Germany GmbH, Erlangen (DE)

(21) Appl. No.: 18/696,789

(22) PCT Filed: Sep. 28, 2022
(86) PCT No.: PCT/EP2022/077053

§ 371 Date: Mar. 28, 2024

(30) Foreign Application Priority Data
Oct. 1, 2021 (EP) 21200537.5

(51) Int. Cl. H02K 3/04; H02K 15/02; H02K 15/06

(52) U.S. Cl. CPC H02K 3/04; H02K 15/02; H02K 15/064

(57) ABSTRACT

A shaped conductor for a winding of an active part of a rotating electric machine, the shaped conductor being formed by a wire and having a first wire portion, which extends along the wire starting from a free end of the shaped conductor and, at the free end, has an end face, and a second wire portion, which adjoins the first wire portion, extends along the wire and has a cross-sectional area.

Shaped conductor for a winding of an active part of a rotating electric machine, active part for a rotating electric machine and associated production method

The present invention relates to a shaped conductor for a winding of an active part of a rotating electric machine, wherein the shaped conductor is formed by a wire and has a first wire portion which extends along the wire from a free end of the shaped conductor and has an end surface at the free end, and a second wire portion which adjoins the first wire portion, extends along the wire, and has a cross-sectional surface, wherein the end surface and the cross-sectional surface each have an edge which consists of a first main portion, a second main portion situated opposite the first main portion, and two transition portions connecting the main portions.

In addition, the invention relates to an active part for a rotating electric machine and to a method for producing an active part for a rotating electric machine.

DE 11 2013 004 290 T5 discloses a rotating electric machine comprising a stator with a stator core and a stator coil which is inserted into slots of the stator core. The stator coil is formed by a plurality of segment coils being welded to one another. The segment coil has a connecting portion at its end.

WO 2019/159737 A1 discloses end portions of U-shaped conductor segments which are inserted into a core and moved against one another. The end portions form a surface with an edge which is rectangular.

When forming a winding of an active part of a rotating electric machine, a plurality of shaped conductors inserted into a core of the active part are usually connected at one end side by being welded to one another. To do this, first wire portions of the shaped conductors are moved against one another such that their end surfaces can be welded to one another. It is desired here to keep the energy input into the shaped conductor low so that in particular an insulating surface layer of the shaped conductor is not melted and functionally impaired. Moreover, an accurate welding surface with a suitable cross-section is to be formed, wherein the creation of sharp edges or corners in the region of the welding surface is to be avoided.

The object of the invention is to provide a more manufacturing-friendly option for producing an active part of a rotating electric machine with a winding formed from shaped conductors.

This object is achieved according to the invention with a shaped conductor of the type mentioned at the beginning by the first wire portion having recesses on the edge which extend from the free end into the first wire portion in such a way that the transition portions of the end surface are longer than the transition portions of the cross-sectional surface, the second main portion of the end surface is shorter than the second main portion of the cross-sectional surface, and the second main portion of the end surface is shorter than the first main portion of the end surface and is shorter than the first main portion of the cross-sectional surface.

The shaped conductor according to the invention for a winding of an active part of a rotating electric machine is formed by a wire. The shaped conductor has a first wire portion. The first wire portion extends from a free end of the shaped conductor along the wire. The first wire portion has an end surface at the free end. The shaped conductor moreover has a second wire portion. The second wire portion adjoins the first wire portion. The second wire portion extends along the wire. The second wire portion has a cross-sectional surface. The end surface and the cross-sectional surface each have an edge. The edge consists of a first main portion, a second main portion, and two transition portions. The second main portion is situated opposite the first main portion. The transition portions connect the main portions. The first wire portion has recesses on the edge. The recesses extend from the free end into the first wire portion in such a way that the transition portions of the end surface are longer than the transition portions of the cross-sectional surface. The recesses moreover extend into the first wire portion in such a way that the second main portion of the end surface is shorter than the second main portion of the cross-sectional surface. The recesses moreover extend into the first wire portion in such a way that the second main portion of the end surface is shorter than the first main portion of the end surface and shorter than the first main portion of the cross-sectional surface.

The invention is based on the idea of shaping the free end of the first wire portion of the shaped conductor by the recesses in such a way that the first wire portion has as few corner regions as possible and the end surface is optimally adapted to a shape to be expected of a welding bead resulting when the shaped conductor is welded to another shaped conductor. To do this, the transition portions and the second main portion of the end surface are shortened compared with the corresponding portions of the cross-sectional surface such that the second main portion of the end surface is shortened compared with the first main portions of the end surface and the cross-sectional surface.

Those regions of the end surface which are remote from the cross-sectional surface by virtue of the recesses thus advantageously no longer have to be melted by a laser beam such that the energy input into the shaped conductor can be reduced. The recesses furthermore approximate the end surface to the shape of a portion, extending over the end surface, of a welding bead which is created when two shaped conductors are welded together. By avoiding the presence of corner regions, which can also be sharp-edged, it is furthermore made easier to cover welded-together shaped conductors with an electrically insulating surface coating, for example by dipping in a gel.

The wire is preferably formed from copper. The shaped conductors can be designed as a multiply bent wire which has, in particular, a U shape or a V shape. The main portions of the cross-sectional surface preferably have the same length. The transition portions of the cross-sectional surface preferably have the same length. The main portions of the cross-sectional surface are preferably longer than the transition portions of the cross-sectional surface. The cross-sectional surface can have the shape of a rectangle or a rounded rectangle.

In a preferred embodiment, the recesses extend into the first wire portion in such a way that the edge of the end surface in the region of the transition portion is, in particular completely, convex. A convex profile of the edge is here further approximated to the shape of the welding bead. Alternatively or additionally, the edge of the cross-sectional surface is convex.

It is moreover preferred in the case of the shaped conductor according to the invention that the recesses extend into the first wire portion in such a way that the transition portions of the end surface each form a curved subportion adjoining the second main portion. The curved subportion represents a good approximation to the shape of the welding bead. The curved subportion particularly preferably has the shape of an arc of a circle.

Moreover, the transition portions of the end surface can, in the case of the shaped conductor according to the invention, each have a straight subportion and the straight subportions run parallel to one another. By virtue of the straight subportions, a sufficiently large welding surface can be ensured which, although it does not correspond exactly to the shape of a welding bead in the region of the straight subportions, it does still offer a good approximation. For this reason, the straight subportion also facilitates the manufacture of the shaped conductor because the straight subportion does not have to be gripped by the recess.

The straight subportion of a respective transition portion of the end surface particularly preferably adjoins the curved subportion. The curved subportion can here transition into the straight subportion at an obtuse angle, in particular an angle of more than 120°. Alternatively or additionally, the curved subportion can transition into the second main portion at an obtuse angle, in particular an angle of more than 120°. The obtuse angles can be identical.

It can moreover be provided that a respective transition portion of the end surface has an angled or curved transition from the straight subportion into the first main portion. The conventional shape of a rounded or beveled corner in the end surface can consequently be obtained in the region of the transition.

The curved subportion is particularly preferably longer than the transition. In other words, the curved subportion has a larger radius of curvature than the curved transition.

In a development of the shaped conductor according to the invention, it can be provided that a side surface of the wire on which the first main portion of the cross-sectional surface lies transitions smoothly from the second wire portion into the first wire portion and continues smoothly to the end surface. The first portion can in particular be understood as a continuation of the second portion in the direction of the free end, modified by the recesses. The recesses can thus be cut into the wire in a simple fashion in terms of manufacturing.

In detail, the main portions of the end surface can run in a straight line and/or parallel to each other. Alternatively or additionally, the main portions of the cross-sectional surface can run in a straight line and/or parallel to each other. It can also be provided that a respective one of the transition portions of the cross-sectional surface has a straight subportion and in particular has an angled or curved transition from the straight subportion into the first main portion or second main portion.

The shaped conductor according to the invention has in particular moreover a second free end situated opposite the first free end.

It can thus be provided that the shaped conductor has a further wire portion which, facing away from the first free end, adjoins the second wire portion. The further wire portion can have a straight wire subportion and a bent wire subportion which has at least two bends and connects the second wire portion to the straight wire subportion. The straight wire subportion is in particular configured to run inside a groove of a core of the active part. The bent wire subportion is in particular configured to position the end surface in such a way that it can be welded to the end surface of another shaped conductor which is arranged in particular in another groove of the or a core of the active part.

In a preferred embodiment, the shaped conductor moreover has a third wire portion which extends from the second free end along the wire and has an end surface at the second free end, and a fourth wire portion which adjoins the third wire portion, extends along the wire, and has a cross-sectional surface. The end surface of the third wire portion and the cross-sectional surface of the fourth wire portion can each have an edge which consists of a first main portion, a second main portion situated opposite the first main portion, and two transition portions connecting the main portions. It is preferably provided that the third wire portion has recesses on the edge which extend into the third wire portion from the second free end in such a way that the transition portions of the end surface of the third wire portion are longer than the transition portions of the cross-sectional surface of the fourth wire portion, the second main portion of the end surface of the third wire portion is shorter than the second main portion of the cross-sectional surface of the fourth wire portion, and the second main portion of the end surface of the third wire portion is shorter than the first main portion of the end surface of the third wire portion and shorter than the first main portion of the cross-sectional surface of the fourth wire portion.

Accordingly, the shaped conductor can be formed at its second free end in a similar fashion to the first free end. All the above explanations about the first and second wire portion can be carried over to the third and fourth wire portion.

In a development, the further wire portion can, facing away from the second free end, adjoin the fourth wire portion and moreover have a second straight wire subportion, which runs parallel to the first straight wire subportion, a second bent wire subportion which has at least two bends and connects the fourth wire portion to the second straight wire subportion, and a direction-reversal portion which connects the first straight wire subportion to the second straight wire subportion and forms a reversal of direction. Such a shaped conductor can also be referred to or understood as a U pin or hairpin of a hairpin winding.

It is alternatively possible that the shaped conductor takes the form of an I pin. To do this, the further wire portion can have a connection subportion which comprises the second free end. Such a shaped conductor has in particular no reversal of direction.

The first main portions of the end surfaces of the first and third wire portion and/or the recesses in the first and third portion can lie on the same side surface of the wire. This is appropriate in particular when the straight wire subportions are arranged in the core in layers of the same parity, for example in a lap winding.

The first main portions of the end surfaces of the first and third wire portion and/or the recesses in the first and third portion can lie on different side surfaces of the wire. This is appropriate in particular when the straight wire subportions are arranged in the core in layers of different parity, for example in a wave winding.

The shaped conductor preferably has an electrically insulating surface layer which does not cover the free end or a respective free end of the shaped conductor, in particular the first and/or the third wire portion.

The object on which the invention is based is moreover achieved by an active part for a rotating electric machine, comprising a plurality of shaped conductors according to the invention and a core, into which the shaped conductors are inserted, wherein the shaped conductors are welded to each other in pairs at the end surfaces in such a way that they form the winding for generating a magnetic field of the active part. The active part can be a stator or an in particular separately excited rotor.

The core is preferably formed from a large number of layered individual laminations and/or individual laminations which are electrically insulated from one another. The core can accordingly also be referred to as a lamination stack. The core can have an end side and a further end side which is situated opposite the end side. The core can have a multiplicity of grooves arranged in the circumferential direction. The grooves can extend from the end side to the further end side. The shaped conductors are preferably inserted into the grooves. In particular, a plurality of shaped conductors in radial layers are inserted into each groove. The first wire portion and/or the second wire portion and/or the third wire portion and/or the fourth wire portion of a respective shaped conductor preferably protrude(s) from the core at the end side. The direction-reversal portions preferably protrude from the core at the further end side. The straight wire subportions preferably run inside the core.

The active part preferably comprises a plurality of insulating means which each line one of the grooves and surround the shaped conductor in the groove. The insulating means can extend axially along the whole groove and/or be designed as insulating paper. The risk of damage to the insulating means when the shaped conductors are inserted into the core is advantageously reduced by the recesses, which makes insertion easier.

The object on which the invention is based is moreover achieved by a rotating electric machine comprising a first active part according to the invention and a second active part, in particular according to the invention, wherein the electric machine is configured to drive a vehicle.

The object on which the invention is based is moreover achieved by a method for producing an active part, in particular a stator or a rotor, for a rotating electric machine, comprising the following steps: Providing a core for the active part; providing a plurality of shaped conductors according to the invention; moving in each case two end surfaces of different shaped conductors against each other in pairs such that the two end surfaces form a welding surface; and welding together the welding surfaces, in particular by means of a laser beam.

All of the explanations about the shaped conductor according to the invention can be analogously transferred to the active part according to the invention, the rotating electric machine according to the invention, and the method according to the invention such that the above described advantages can be obtained with these too.

Further advantages and details of the present invention can be found in the exemplary embodiments described below and with reference to the drawings. The latter are schematic illustrations and:

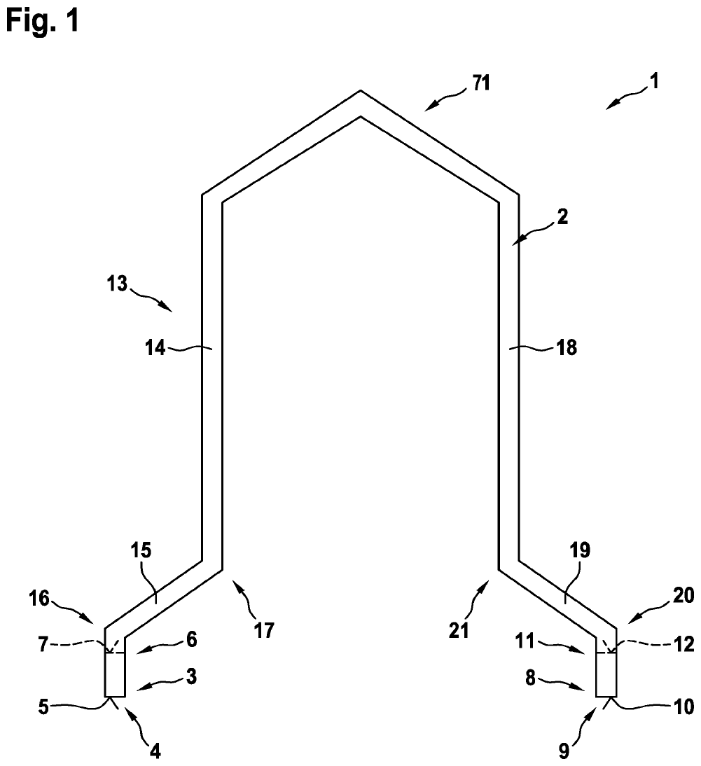

FIG. 1 shows a schematic diagram of a first exemplary embodiment of the shaped conductor according to the invention;

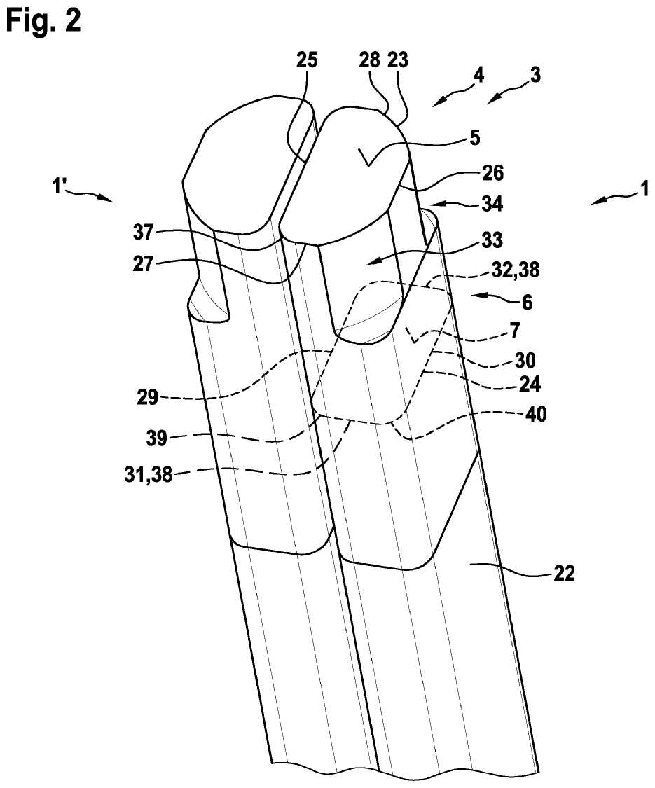

FIG. 2 shows a perspective view in detail of the first free end of two shaped conductors according to the first exemplary embodiment;

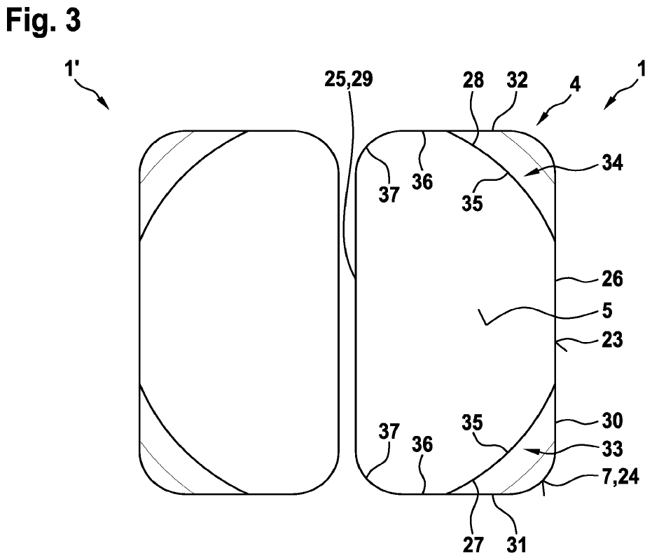

FIG. 3 shows a plan view of the end surfaces of two shaped conductors according to the first exemplary embodiment;

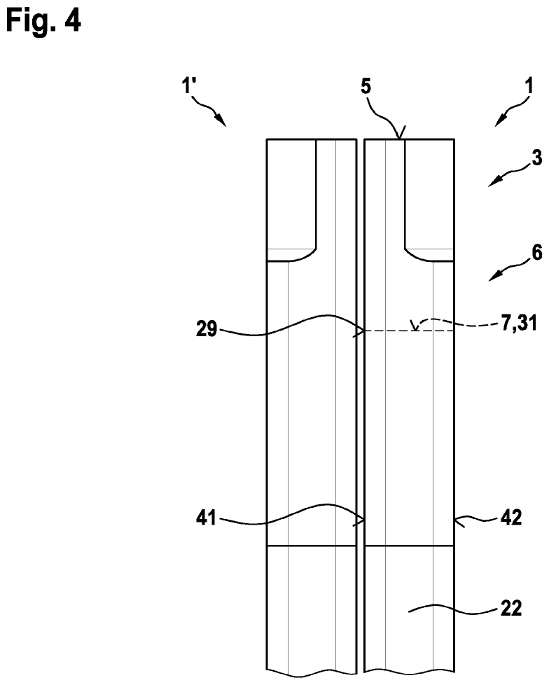

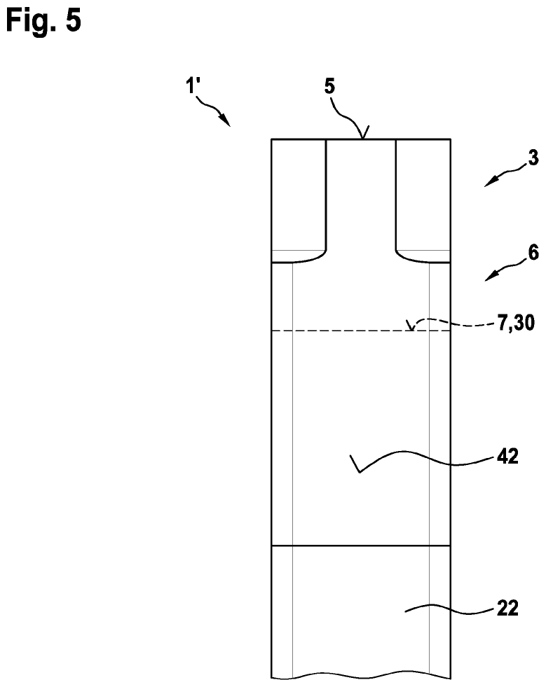

FIGS. 4 and 5 each show a side view of the shaped conductor shown in FIG. 3;

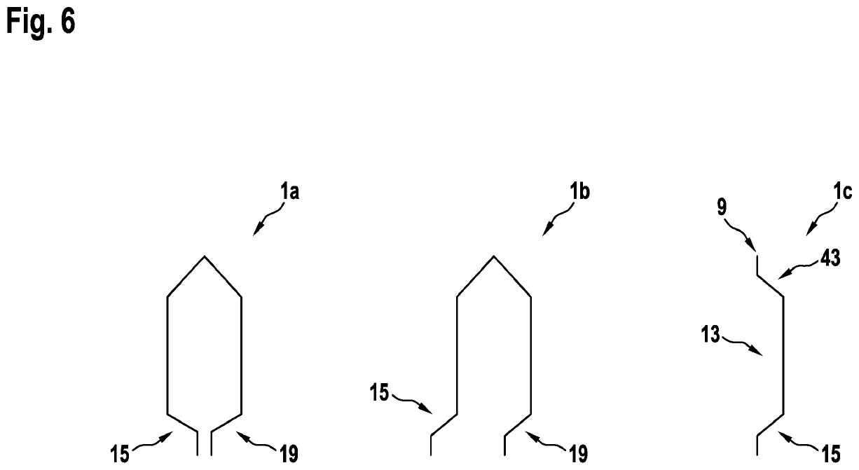

FIG. 6 shows schematic diagrams of further exemplary embodiments of the shaped conductor according to the invention;

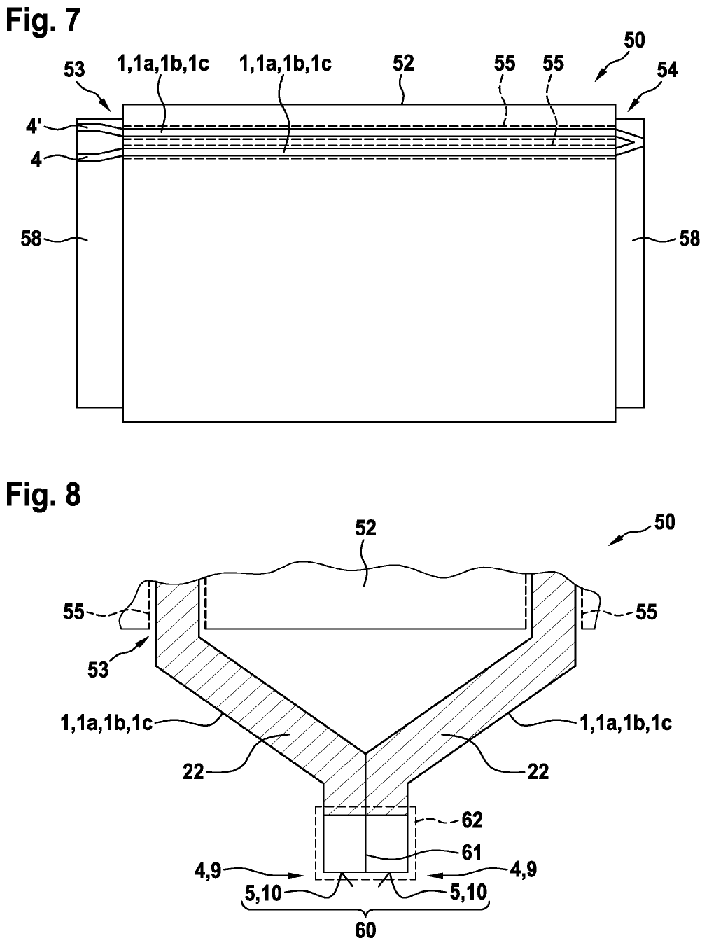

FIGS. 7 and 8 each show a schematic diagram of an exemplary embodiment of the active part according to the invention;

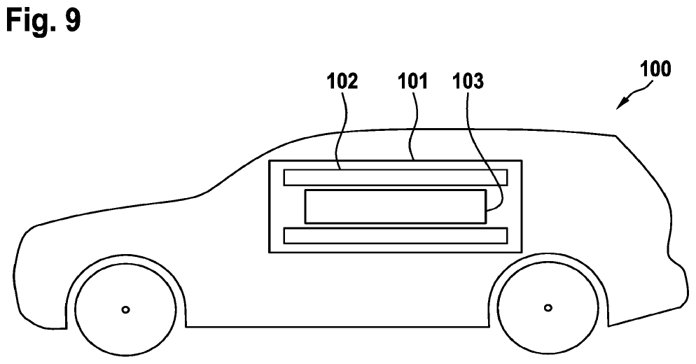

FIG. 9 shows a schematic diagram of a vehicle with an exemplary embodiment of the active part according to the invention.

FIG. 1 is a schematic diagram of a first exemplary embodiment of a shaped conductor 1 which is formed by a wire 2, which is for example made from copper.

The shaped conductor 1 has a first wire portion 3 which extends from a first free end 4 of the shaped conductor 1 along the wire 2 and has an end surface 5 at the free end 4. Next to it, the shaped conductor 1 has a second wire portion 6 which adjoins the first wire portion 3. The second wire portion 6 extends along the wire 2 and has a cross-sectional surface 7.

According to the present exemplary embodiment, the shaped conductor 1 moreover has a third wire portion 8 which extends from a second free end 9, situated opposite the first free end 4, along the wire 2 and has an end surface 10 at the second free end 9. Next to it, the shaped conductor 1 has a fourth wire portion 11 which adjoins the third wire portion 8. The fourth wire portion 11 extends along the wire 2 and has a cross-sectional surface 12.

Moreover, in this exemplary embodiment, a further wire portion 13 is provided which, facing away from the first free end 4, adjoins the second wire portion 6. The further wire portion 13 has a first straight wire subportion 14 and a first bent wire subportion 15. The first bent wire subportion 15 has two bends 16, 17 and connects the second wire portion 6 to the straight wire subportion 14. In addition, the further wire portion 13, facing away from the second free end 9, adjoins the fourth wire portion 11. The further wire portion 13 moreover has a second straight wire subportion 18 and a second bent wire subportion 19 which has at least two bends 20, 21 and connects the fourth wire portion 11 to the second straight wire subportion 18. In the present exemplary embodiment, the bent wire subportions 15, 19 face away from each other.

A direction-reversal subportion 71 of the further wire portion 13 connects the first straight wire subportion 14 to the second straight wire subportion 18 and forms a 180° reversal of direction such that the straight wire subportions 14, 18 run parallel to and apart from each other. To do this, the direction-reversal subportion 71 is bent multiple times.

The shaped conductor 1 moreover has in some places an electrically insulating surface layer 22 (see FIG. 2, FIG. 4, and FIG. 5) which covers the further wire portion 13 completely and the second wire portion 6 and the fourth wire portion 11 at least partially.

FIG. 2 and FIG. 3 each show the first free end 4 of two shaped conductors 1, 1′ according to the first exemplary embodiment, wherein FIG. 2 is a perspective view and FIG. 3 a plan view.

The end surface 5 and the cross-sectional surface 7 each have an edge 23, 24. The edge 23 of the end surface 5 consists of a main portion 25, a second main portion 26 situated opposite the first main portion 25, and two transition portions 27, 28 connecting the main portions 25, 26. The main portions 25, 26 of the end surface 5 here run parallel to each other. Correspondingly, the edge 24 of the cross-sectional surface 7 consists of a first main portion 29, a second main portion 30 situated opposite the first main portion 29, and two transition portions 31, 32 connecting the main portions 29, 30. The main portions 29, 30 of the cross-sectional surface 7 here run parallel to each other.

The shaped conductor 1 is characterized in that the first wire portion 3 has two recesses 33, 34 on its edge which extend from the free end 4 into the first wire portion 3 in such a way that
the transition portions 27, 28 of the end surface 5 are longer than the transition portions 31, 32 of the cross-sectional surface 7,
the second main portion 26 of the end surface 5 is shorter than the second main portion 30 of the cross-sectional surface 7 and
the second main portion 26 of the end surface 5 is shorter than the first main portion 25 of the end surface 5 and shorter than the first main portion 29 of the cross-sectional surface 7.

In detail, a convex profile of the edge 23 of the end surface 5 is implemented by the recesses 33, 34, in which the transition portions 27, 28 of the end surface 5 each form a subportion 35 in the shape of an arc of a circle and adjoining the second main portion 26, and a straight subportion 36. The subportion 35 in the shape of an arc of a circle here transitions into the straight subportion 36 at an obtuse angle. Likewise, the subportion 35 in the shape of an arc of a circle transitions into the second main portion 26 at an obtuse angle.

A respective transition portion 27, 28 of the end surface 5 moreover has a curved transition 37 from the straight subportion 36 into the first main portion 25. A radius of curvature of the subportion 35 in the shape of an arc of a circle is here larger than that of the transition 37. Put differently, the subportion 35 in the shape of an arc of a circle is longer than the transition 37. The transition 37 here tangentially adjoins the straight subportion 36 and the transition 37 such that it has the shape of a quarter-circle.

At the cross-sectional surface 7, the main portions 29, 30 run parallel to each other and have the same length. The transition portions 31, 32 each have a straight subportion 38, wherein the straight subportions 38 run parallel to each other and have the same length. A respective transition portion 31, 32 of the cross-sectional surface 7 moreover has two curved transitions 39, 40 on both sides of the straight subportion 38 into the first main portions 29, 30. The transitions 39, 40 here tangentially adjoin the straight subportion 36 and the corresponding main portion 29, 30 such that the transitions 39, 40 have the shape of a quarter-circle.

As can be seen in FIG. 3, a welding surface with a circular form with four truncated chords is formed with the aid of the recesses 33, 34 on the end surfaces 5 of the shaped conductors 1, 1′.

FIGS. 4 and 5 are in each case a side view of the shaped conductors 1, 1′, wherein FIG. 4 is a side view of the transition portion 31 of the cross-sectional surface 7 and FIG. 5 is a side view of the second main portion 30 of the cross-sectional area 7.

It can be clearly seen in particular in FIG. 4 that a side face 41 of the wire 2 on which the first main portion 29 of the cross-sectional surface 7 and the recesses 33, 34 lie transitions smoothly from the second wire portion 6 into the first wire portion 3 and continues smoothly to the end surface 5.

The third wire portion 8 and the fourth wire portion 11 are designed identically to the first wire portion 3 and the second wire portion 11 such that all explanations can be transferred correspondingly. In the present exemplary embodiment, the first main portions 29 of the end surfaces 5 of the first and third wire portion 3, 8 lie on the same side face 41 of the wire 2. Alternatively, the first main portion of the end surface of the third wire portion 8 lies on a different side face 42 of the wire 2.

FIG. 6 shows schematic diagrams of further exemplary embodiments of the shaped conductor 1a, 1b, 1c.

In the second exemplary embodiment of the shaped conductor 1a, the bent wire subportions 15, 19 face each other. In the third exemplary embodiment of the shaped conductor 1b, the bent wire subportions 15, 19 face in the same direction. The shaped conductors 1, 1a, 1b can also be understood as U pins or hairpins for a hairpin winding.

In the fourth exemplary embodiment of the shaped conductor 1c, the further wire portion has the straight wire subportion 13, the bent wire subportion 15, and a connecting subportion 43 comprising the second free end 9. A direction-reversal subportion 71 is not provided. The shaped conductor 1c can also be understood as an I pin for a hairpin winding.

FIG. 7 shows a schematic diagram of an exemplary embodiment of an active part 50 for a rotating electric machine 101 (cf. FIG. 9).

The active part 50 comprises a core 52 which can be formed in a generally known manner from a large number of layered individual laminations (not shown) which are electrically insulated from one another and in this case can also be understood as a lamination stack. The core 52 has an end side 53 and a further end side 54 which is situated opposite the end side 53. Furthermore, a plurality of grooves 55 which are arranged in the circumferential direction are formed in the core 52, which grooves extend from the end side 53 to the further end side 54 in the axial direction and axially pass through the core 52 entirely. Only two of the grooves 55 are illustrated, purely schematically, in FIG. 7.

The active part 50 moreover comprises a plurality of shaped conductors 1, 1a, 1b, 1c according to one of the above described exemplary embodiments which are inserted into the core 52. Just a single shaped conductor 1, 1a, 1b, 1c is illustrated schematically in FIG. 7. The shaped conductors 1, 1a, 1b, 1c extend from the end side 53 to the further end side 54. The shaped conductors 1, 1a, 1b, 1c form purely schematically illustrated end windings 58 at both end sides 53, 54.

FIG. 8 is a view of a detail of two shaped conductors 1, 1a, 1b, 1c in the region of their free ends 4, 9.

As is apparent, the shaped conductors 1, 1a, 1b, 1c protrude from the core 52 at its end side 53. The free ends 4, 9 each have an end surface 5, 10 which extends substantially perpendicularly to the axial direction or perpendicularly to the direction of extent of the shaped conductors 1, 1a, 1b, 1c. The end surfaces 5, 10 are joined together in order to form a pair 60. A gap between the end surfaces 5, 10 or contact between the end surfaces 5, 10 forms a boundary region 61 here.

Each pair 60 of the end surfaces 9 are welded to one another by means of a laser beam such that the free ends 5, 10 or the shaped conductors 1, 1a, 1b, 1c are electrically conductively and mechanically connected to one another. One or more windings is or are formed by the welding, which windings are configured to generate a magnetic field for generating an electromotive force of the rotating electric machine 101 (see FIG. 9) when current is applied. The active part is designed as a stator 102 or rotor 103 (see FIG. 9).

FIG. 8 moreover shows schematically by hatching an outer electrically insulating surface layer 22 and a surface coating 62 which after the welding has been applied to the shaped conductors 1, 1a, 1b, 1c in such a way that it overlaps the insulating surface layer 22. The surface coating 62 is, for example, produced by dipping the free ends 4, 9 into an immersion bath with a hardenable gel.

FIG. 9 is a schematic diagram of a vehicle 100 with an exemplary embodiment of a rotating electric machine 101. The electric machine 101 has a stator 102 and a rotor 103. The stator 102 and/or the rotor 103 is/are designed as an active part 50 according to one of the above described exemplary embodiments.

The electric machine 101 is configured to drive the vehicle 100. The vehicle 100 is accordingly a battery-electric vehicle (BEV) or a hybrid vehicle.

1. A shaped conductor for a winding of an active part of a rotating electric machine, wherein the shaped conductor is formed by a wire and has a first wire portion which extends along the wire from a free end of the shaped conductor and has an end surface at the free end, and a second wire portion which adjoins the first wire portion, extends along the wire, and has a cross-sectional surface, wherein the end surface and the cross-sectional surface each have an edge which consists of a first main portion, a second main portion situated opposite the first main portion, and two transition portions connecting the main portions,
wherein
the first wire portion has two recesses on its edge which extend from the free end into the first wire portion in such a way that
the transition portions of the end surface are longer than the transition portions of the cross-sectional surface,
the second main portion of the end surface is shorter than the second main portion of the cross-sectional surface and
the second main portion of the end surface is shorter than the first main portion of the end surface and shorter than the first main portion of the cross-sectional surface.

2. The shaped conductor as claimed in claim 1, wherein
the recesses extend into the first wire portion in such a way that the transition portions of the end surface each form a subportion which is curved, in particular in the shape of an arc of a circle, and adjoins the second main portion.

3. The shaped conductor as claimed in claim 1, wherein
the transition portions of the end surface can each have a straight subportion and the straight subportions run parallel to one another.

4. The shaped conductor as claimed in claim 2, wherein
the straight subportion of a respective transition portion of the end surface adjoins the curved subportion.

5. The shaped conductor as claimed in claim 4, wherein
the curved subportion transitions into the straight subportion at an obtuse angle and/or transitions into the second main portion at an obtuse angle.

6. The shaped conductor as claimed in claim 3, wherein
a respective transition portion of the end surface has an angled or curved transition from the straight subportion into the first main portion.

7. The shaped conductor as claimed in claim 6,
wherein the curved subportion is longer than the transition.

8. The shaped conductor as claimed in claim 1 wherein
a side face of the wire on which the first main portion of the cross-sectional surface lies transitions smoothly from the second wire portion into the first wire portion and continues smoothly to the end surface and/or
the main portions of the end surface run in a straight line and/or parallel to each other and/or
the main portions of the cross-sectional surface run in a straight line and/or parallel to each other and/or
a respective one of the transition portions of the cross-sectional surface has a straight subportion and has in particular an angled or curved transition from the straight subportion into the first main portion.

9. The shaped conductor as claimed in claim 1, furthermore having
a second free end situated opposite the first free end.

10. The shaped conductor as claimed in claim 9, furthermore having
a further wire portion which, facing away from the first free end, adjoins the second wire portion, and has
a straight wire subportion and
a bent wire subportion which has at least two bends and connects the second wire portion to the straight wire subportion.

11. The shaped conductor as claimed in claim 10, furthermore having
a third wire portion which extends from the second free end along the wire and has an end surface at the second free end, and a fourth wire portion which adjoins the third wire portion, extends along the wire, and has a cross-sectional surface, wherein the end surface of the third wire portion and the cross-sectional surface of the fourth wire portion each have an edge which consists of a first main portion, a second main portion situated opposite the first main portion, and two transition portions connecting the main portions, wherein the third wire portion has recesses on the edge which extend into the third wire portion from the second free end in such a way that
the transition portions of the end surface of the third wire portion are longer than the transition portions of the cross-sectional surface of the fourth wire portion,
the second main portion of the end surface of the third wire portion is shorter than the second main portion of the cross-sectional surface of the fourth wire portion, and
the second main portion of the end surface of the third wire portion is shorter than the first main portion of the end surface of the third wire portion and shorter than the first main portion of the cross-sectional surface of the fourth wire portion.

12. The shaped conductor as claimed in claim 10, wherein
the further wire portion which, facing away from the second free end, adjoins the fourth wire portion, and moreover has
a second straight wire subportion which runs parallel to the first straight wire subportion,
a second bent wire subportion which has at least two bends and connects the fourth wire portion to the straight wire subportion, and
a direction-reversal portion which connects the first straight wire subportion to the second straight wire subportion and forms a reversal of direction.

13. The shaped conductor as claimed in claim 11, wherein
the first main portions of the end surfaces of the first and third wire portion lie on the same side face or on different side faces of the wire.

14. An active part, in particular a stator or rotor, for a rotating electric machine, comprising a plurality of shaped conductors as claimed in claim 1 and a core into which the shaped conductors are inserted, wherein the shaped conductors are welded to each other in pairs at the end surfaces in such a way that they form the winding for generating a magnetic field of the active part.

15. A method for producing an active part, in particular a stator or a rotor, for a rotating electric machine, comprising the following steps:
providing a core for the active part;
providing a plurality of shaped conductors as claimed in claim 1;
moving in each case two end surfaces of different shaped conductors against each other in pairs such that the two end surfaces form a welding surface; and
welding together the welding surfaces, in particular by means of a laser beam.

16. The shaped conductor as claimed in claim 2, wherein
the transition portions of the end surface can each have a straight subportion and the straight subportions run parallel to one another.

17. The shaped conductor as claimed in claim 3, wherein
the straight subportion of a respective transition portion of the end surface adjoins the curved subportion.

18. The shaped conductor as claimed in claim 4, wherein
a respective transition portion of the end surface has an angled or curved transition from the straight subportion into the first main portion.

19. The shaped conductor as claimed in claim 2, wherein
a side face of the wire on which the first main portion of the cross-sectional surface lies transitions smoothly from the second wire portion into the first wire portion and continues smoothly to the end surface and/or
the main portions of the end surface run in a straight line and/or parallel to each other and/or
the main portions of the cross-sectional surface run in a straight line and/or parallel to each other and/or
a respective one of the transition portions of the cross-sectional surface has a straight subportion and has in particular an angled or curved transition from the straight subportion into the first main portion.

20. The shaped conductor as claimed in claim 2, furthermore having
a second free end situated opposite the first free end.
